(19) United States
(12) Patent Application Publication
(10) Pub. No.: US 2012/0204397 A1
(43) Pub. Date: Aug. 16, 2012

(54) Drinking Assistant

(76) Inventor: Chih-Cheng Tai, Santa Clara, CA (US)

(21) Appl. No.: 13/367,561

(22) Filed: Feb. 7, 2012

Related U.S. Application Data
(60) Provisional application No. 61/441,973, filed on Feb. 11, 2011.

(51) Int. Cl. B65D 25/48; B23P 11/00

(52) U.S. Cl. 29/407.09; 220/716

(57) ABSTRACT

A drinking assistant to be used on a beverage can. The drinking assistant includes a cover portion coupled to the top of the beverage can and a skirt portion coupled to the outer surface of the cylindrical body of the drinking container. The cover portion and the skirt portion form a lid structure. The cover portion can have a recess portion having an edge substantially aligned with the edge of an opening on the top of the beverage can.

### CROSS-REFERENCE TO RELATED APPLICATION(S)

The present invention claims priority to the U.S. provisional patent application Ser. No. 61/441,973, titled DRINKING ASSISTANT, filed on Feb. 11, 2011, which is incorporated by reference in its entirety. The present invention also claims priority to a U.S. design patent application Ser. No. 29/402,356, titled DRINKING ASSISTANT, filed on Sep. 22, 2011, which is incorporated by reference in its entirety.

### FIELD OF THE INVENTION

The present invention relates to a drinking assistant attachable to a drinking container. More specifically, the present invention relates to a cover for beverage cans, such that the users are able to enjoy drinks without direct contacting the beverage cans.

### BACKGROUND OF THE INVENTION

Millions of canned beverages are sold and consumed by consumers every year, such as soda, beer, juice, and energy drink. Before being sold to buyers, the beverage cans are often transported from factories to stores and stored for a long time before they are used by the consumers. During that period of time, contaminants, such as dust and bacteria, fall on the surface of the cans. Due to groove structure formed on the top of a beverage can, it is not easy to wipe out the contaminants. However, after buying canned beverage, a user often open and drink directly therefrom. While drinking, a user can drink beverage along with contaminants and exposed to healthy risks. Not only for a beverage can, any other drinking containers, such as a cup with an open top, can suffer from the same problem.

### SUMMARY OF THE INVENTION

In some embodiments, the drinking assistant is able to avoid a user's mouth directly from touching the surface of a drinking container. In some embodiments, the drinking assistant comprises a lid structure to be attached to the top of the drinking container. In some embodiments, the drinking assistant can provide the function of can-identification for users, such that the users are able to identify which one is their can. In some other embodiments, the drinking assistant is able to provide a function of mixing multiple drinks, such as making a cocktail drink.

In one aspect, a drinking assistant comprises a cover portion configured to cover at least a portion of a top of a drinking can, wherein the cover portion containing a recess opposite to the side of the skirt portion and a skirt portion extending from the cover portion along a contour of an edge of the drinking can. In some embodiments, the cover portion and the skirt portion forms a lid structure to be instantly attached to and removed from the drinking can. In other embodiments, the cover portion and the skirt portion forms a groove structure capable of engaging a rim of the drinking can. In some other embodiments, the recess forms an incomplete circle on the cover portion. In some embodiments, the recess is opposite to an opening ring of the drinking can. In other embodiments, the recess is substantially aligned with a contour of an opening of the drinking can. In some other embodiments, the cover portion contains an edge perpendicular to the cover portion extending toward an opening of the drinking can. In some embodiments, the edge elastically fit with a ridge of the opening. In other embodiments, the drinking assistant further comprises a flow stopper on the cover portion capable of preventing fluid from flowing on the top of the drinking can. In some other embodiments, the flow stopper joining with the recess forms an end of the cover portion. In some embodiments, the drinking assistant comprises a material of a silicone, a plastic, a polymer, an elastomer, a metal, or a combination thereof. In other embodiments, the skirt portion contain a surface having an area sufficient for resting a human lip. In some other embodiments, the drinking assistant further comprises an identification system. In some embodiments, the identification system comprises a symbol, text, or a combination thereof. In some other embodiments, the identification system is embossed or craved on the drinking assistant. In some other embodiments, the cover portion surrounding less than whole of a rim of the drinking can

In another aspect, a method of using a drink assistant comprising attaching a cover with a can covering at least a portion of a top of the can and aligning a recess of the cover with an opening of the can. In some embodiments, the recess forms an opening facing an opening-ring of the can. In other embodiments, the cover forms an insulation layer, such that a user is able to drink the beverage without having a lip of the user to touch the can.

In a further aspect, a drinking assistant comprises a cover member comprising a recess, wherein the recess has an area substantially similar in size of an opening area of a beverage can, a skirt member having a contour substantially parallel to an area of the beverage can between a cylindrical body and a rim of the beverage can, a rim member connecting the cover member and a skirt member forming a groove capable of engaging the rim of the beverage can, a flow barrier connecting with the rim member such that beverage is confined on the cover member, and an identification symbol such that the beverage can is able to be identified.

### BRIEF DESCRIPTION OF THE DRAWINGS

FIG. 1 is a perspective view of a drinking assistant shown with a drinking container according to some embodiments of the present invention.

FIG. 2 is a cross-sectional view of a drinking assistant attached to a drinking container according to some embodiments of the present invention.

FIG. 3A is a top view of a drinking assistant with a partial cover portion according to some embodiments of the present invention.

FIG. 3B is a top view of another drinking assistant with a large cover portion according to other embodiments of the present invention.

FIG. 4A is a perspective view of a drinking assistant with a lip rest attached with a drinking container according to some embodiments of the prevent invention.

FIG. 4B is a cross-sectional of a drinking assistant with a lip rest attached with a drinking container according to some embodiments of the prevent invention.

FIG. 5A is a perspective view of a drinking mixer attached with a drinking container according to some embodiments of the present invention.

FIG. 5B is a top view of a drinking mixer according to some embodiments of the present invention.

FIG. 6 is a front view of a drinking mixer with an outlet and a plug shown in conjunction with a drinking container according to some embodiments of the present invention.

FIG. 7 is a perspective view of a drinking mixer and a removable storage shown in conjunction with a drinking container according to some embodiments of the present invention.

FIG. 8A is a perspective view of a drinking assistant attached with a drinking container with an open top according to some embodiments of the present invention.

FIG. 8B is a perspective view of a drinking assistant according to some embodiments of the present invention.

FIG. 9A is a perspective view of a drinking assistant with an identification system according to some embodiments of the present invention.

FIG. 9B illustrates a list of various identifiers according to some embodiments of the present invention.

FIG. 9C is a perspective view of another identification system according to some embodiments of the present invention.

FIG. 10 is a flowchart illustrating a method of using the drinking assistant in accordance with the some embodiments of the present invention.

FIG. 11 is a right top perspective view of an elastic band 10 according to some embodiments of the present invention.

FIG. 12 illustrates the application of the elastic band in accordance with some embodiments.

FIG. 13 is a right top perspective view of an elastic illuminating device according to some embodiments of the present invention.

FIG. 14 is a block diagram of the elastic illuminating device according to some embodiment of the present invention.

FIG. 15 is an elastic illuminating device according to some embodiments of the present invention.

FIG. 16 is a schematic diagram illustrating an identification match system on the elastic illuminating device in accordance with some embodiments of the present invention.

### DETAILED DESCRIPTION OF THE PREFERRED EMBODIMENTS

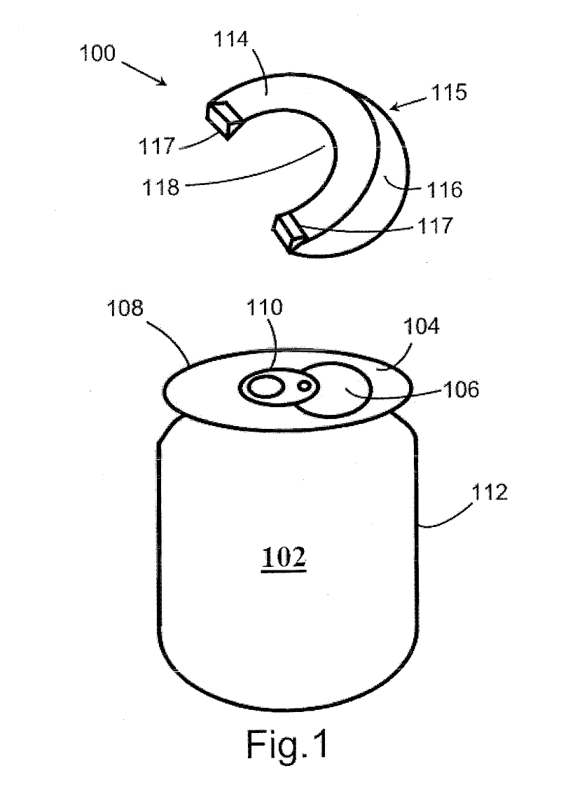

FIG. 1 illustrates a perspective view of a drinking assistant 100 shown in conjunction with a typical can according to some embodiments of the present invention. A can 102 is able to include a cylindrical body 112, a top 104, a rim 108 circling the top 104, an opening 106 formed on the top 104, and a tab 110. The cylindrical body 112 can be coupled to the top 104. The drinking assistant 100 is able to include a cover portion 114, a skirt portion 116, and a recess portion 118. In some embodiments, the skirt portion 116 couples with the cover portion 114 to form a lid structure 115. The recess portion 118 can be formed on the cover portion 114.

The drinking assistant 100 can be made of elastic materials, such as rubber, plastics, silicone, polymer, elastomer, metal, and/or other materials, for fitting to the shape of the can 102, which can have various sizes.

The drinking assistant 100 can be secured to the can 102 in multiple manners, including but not limited to, a friction grip, a snap grip, an adhesive, or relying upon some securing structure. While the drinking assistant 100 is being applied to the can 102, the cover portion 114 can be coupled to the top 104, the skirt portion 116 can be coupled to the outer surface of the cylindrical body 112, and the edge of the recess portion 118 can be substantially aligned with the rim of the opening 106. In that way, the beverage in the can 102 can flow in and out of the opening 106 without touching the top 104 or the cylindrical body 112 of the can 102. While a user is drinking the beverage in the can 102, the user's lip can rest on the skirt portion 116 and/or the cover portion 114, such that touching the user's lip with the can 102 is able to be avoided.

In some embodiments, a stopper 117 can be formed or mounted on the cover portion 114 and posited at the edge of the drinking assistant 100 in opposite to the skirt portion 116 for preventing liquid reverse flow.

The drinking assistant 100 can be secured to the can 102 via elasticity, snap, pressure and/or any other mechanism. For example, in some embodiments, the drinking assistant 100 can be slightly bigger than the rim 108 of the can 102. A user can pinch the drinking assistant 100 so that the drinking assistant 100 can fit onto the top 104 of the can 102, and after a user stops pinching the drinking assistant 100, the drinking assistant 100 can expand back to its original shape to secure on the top 104 of the can 102. In another embodiment, the drinking assistant 100 can be slightly smaller than the rim 108 of the can 102. A user can stretch the drinking assistant 100 to fit the rim 108 of the top 104, and after a user stops stretching the drinking assistant 100, the drinking assistant 100 is secured on the top 104 of the can 102 by naturally shrinking back to its original size. A corresponding method to release the drinking assistant 100 from the can 102 is to use a method with reverse steps stated above. The drinking assistant 100 is reusable on the same or different cans.

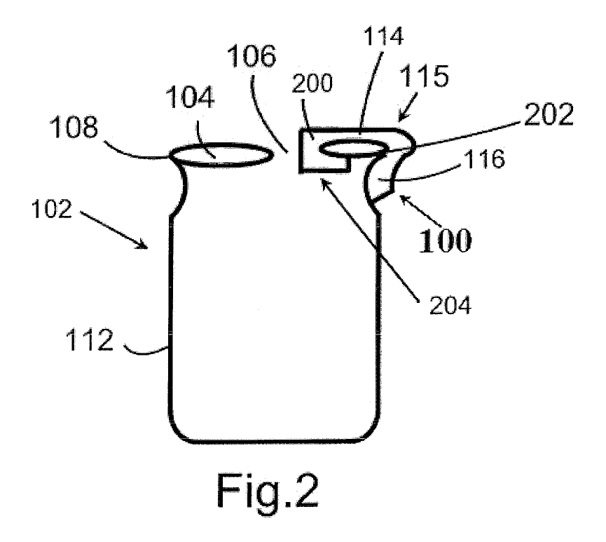

FIG. 2 illustrates a cross-sectional view of the drinking assistant 100 while being attached with the can 102 according to some embodiments of the present invention. The drinking assistant 100 can include a groove 202 to be formed underneath the lid structure 115 and between the cover portion 114 and the skirt portion 116 for further enforcing the lid structure 115 to engage with the drinking assistant 100.

In some embodiments, the recess portion 118 (see FIG. 1) can include a protruding part 200 at the edge, extending downwardly into the can 102 to fit the rim of the opening 106 on the can 102 for preventing the leaking of the beverage.

In some embodiments, the recess portion 118 can further include a C-shape structure 204 at the edge to clip the top 104 of the can 102 for further preventing the leaking of the beverage.

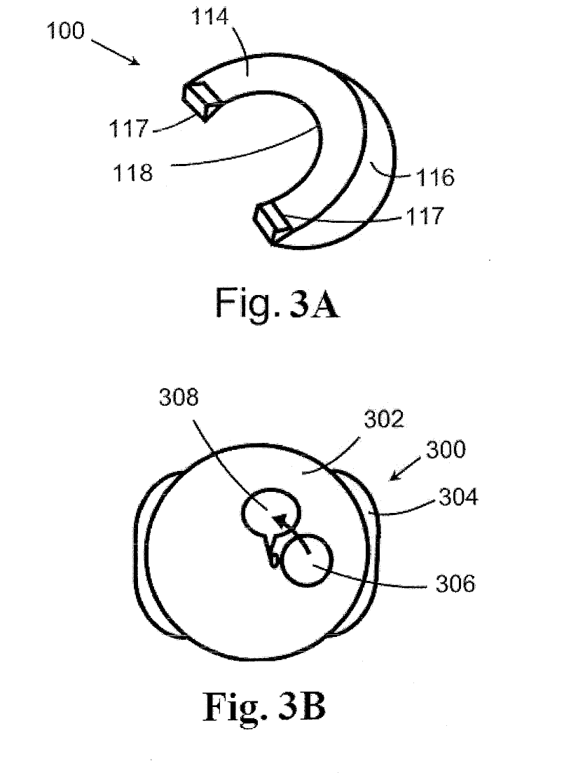

A cover portion can be formed in different sizes. FIGS. 3A and 3B illustrate top views of drinking assistants with different sizes of cover portions according to some embodiments of the present invention. The drinking assistant 100 in FIG. 3A can cover partial area of the top 104. The whole-size drinking assistant 300 in FIG. 3B can cover full area of the top 104. The whole-size drinking assistant 300 can include a full cover portion 302 and a full skirt portion 304. Furthermore, the whole-size drinking assistant 300 can include a hole 306 substantially aligned with the opening 106 of the can 102 for allowing liquid flow in or out of the can 102. In some embodiments, a cap 308 can be applied to the hole 306 for preventing spillage or sanitary purpose. The cap 308 can have a hinge design for a user to open or close his/her can. The cap 308 is also applicable to the drinking assistant 100 as shown in FIG. 3A.

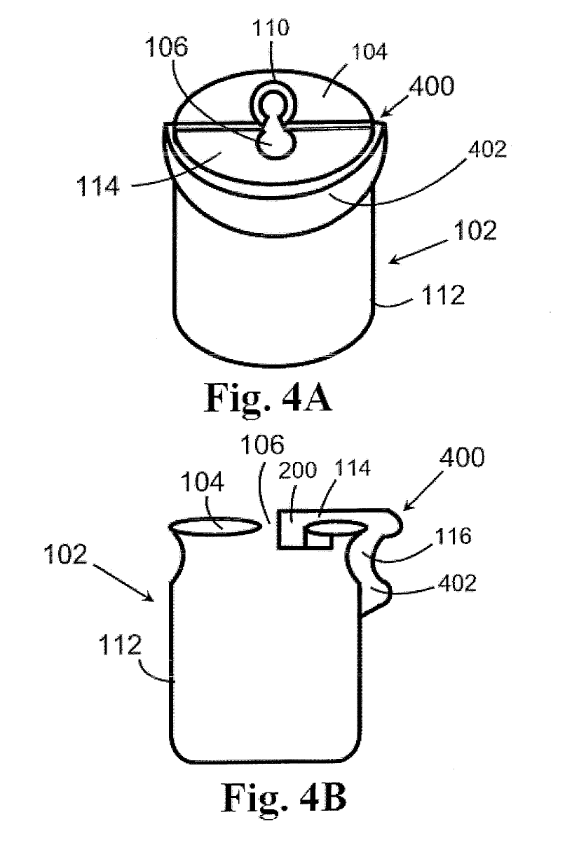

FIGS. 4A and 4B are a perspective view and a cross-sectional view of a drinking assistant with an attached a lip rest according to some embodiments of the prevent invention. The drinking assistant with a lip rest 400 can include the cover portion 114, the recess portion 118, and the lip rest 402. The lip rest 402 is a modified design of a skirt portion for a user to comfortably put his/her lower lip on it and to prevent a user's lip touching the surface of the cylindrical body 112. The lip rest 402 can be a prolonged skirt portion and shaped for being rested with a user's lip.

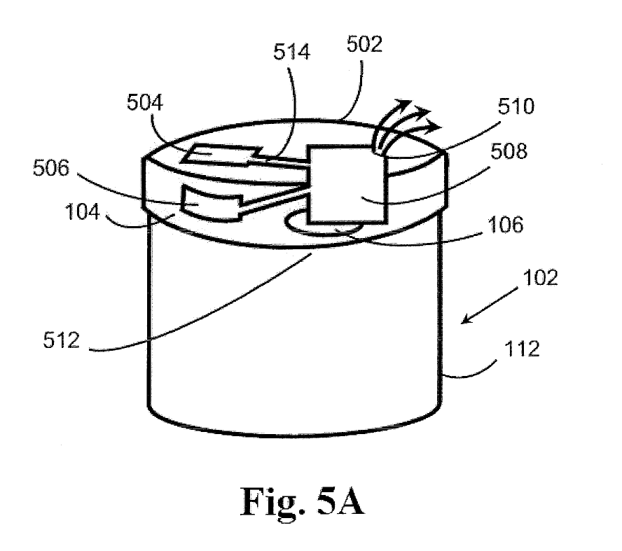

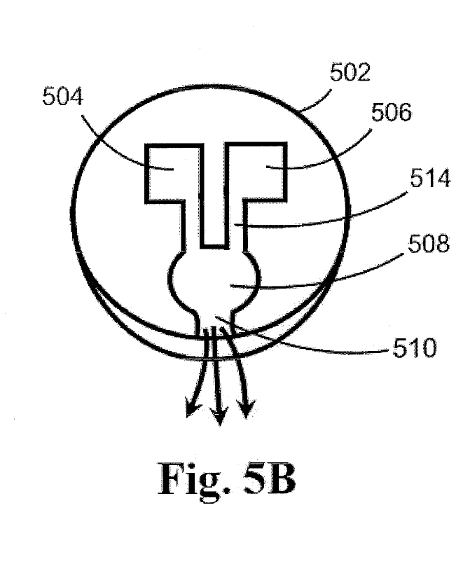

FIG. 5A is a perspective view of a drinking mixer attached with a can according to some embodiments of the present invention. FIG. 5B is a top view of the drinking mixer. The drinking mixer 502 can be formed within the drinking assistant or additionally applied on/add on the drinking assistant. The drinking mixer 502 can include a first storage 504 and a second storage 506 for storing fluid or gas inside, and a chamber 508 for mixing liquid in the can 102 with the fluid or gas stored in the first storage 504 and the second storage 506. The number of storage can be one or more. In some embodiments, the drinking mixer 502 can further include a flow channel 514, which can connect the storage 504 or 506 to the chamber 508, and at least one aperture 512 at the bottom of the chamber 508 and/or at least one aperture 510 at the top of the chamber 508 for liquid in the can 102 flowing into or out of the chamber 508. The drinking assistant can flavor original liquid or beverage in the can by being applied with the drinking mixer.

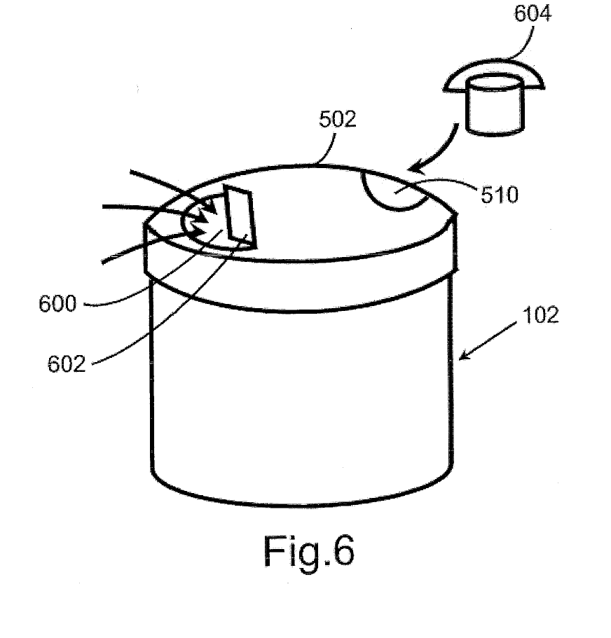

FIG. 6 illustrates a front view of a drinking mixer with an outlet and a plug shown in conjunction with a drinking container according to some embodiments of the present invention. The drinking mixer 502 can further include at least one outlet 600 for refilling the fluid, liquid or gas and at least one cover 602 to cover the outlet 600, and a plug 604 for applying to the aperture 510 of the chamber 508 for preventing leakage or sanitary purpose.

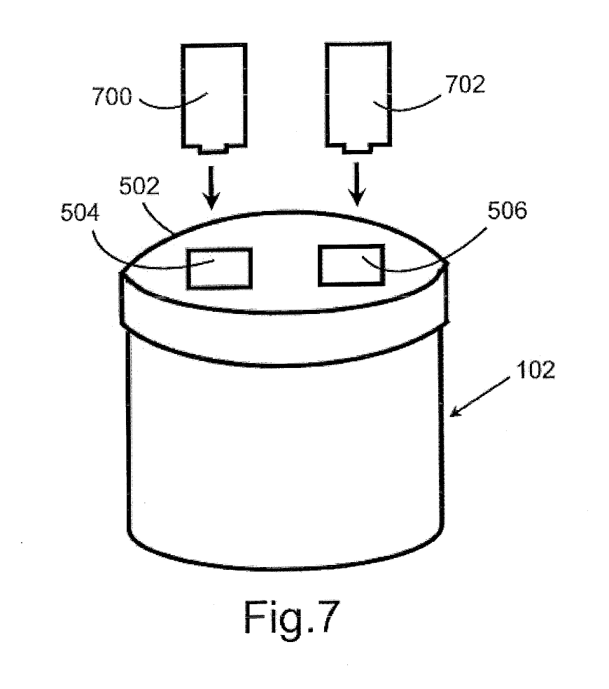

FIG. 7 illustrates a perspective view of a drinking mixer and a removable storage shown in conjunction with a drinking container according to some embodiments of the present invention. To increase the capacity of the storage of the drinking mixer 502 or to refill the storage of the drinking mixer 502, a removable storage can be used. In FIG. 7, a first removable storage 700 can be coupled to the first storage 504 and a second removable storage 702 can be coupled to the second storage 506.

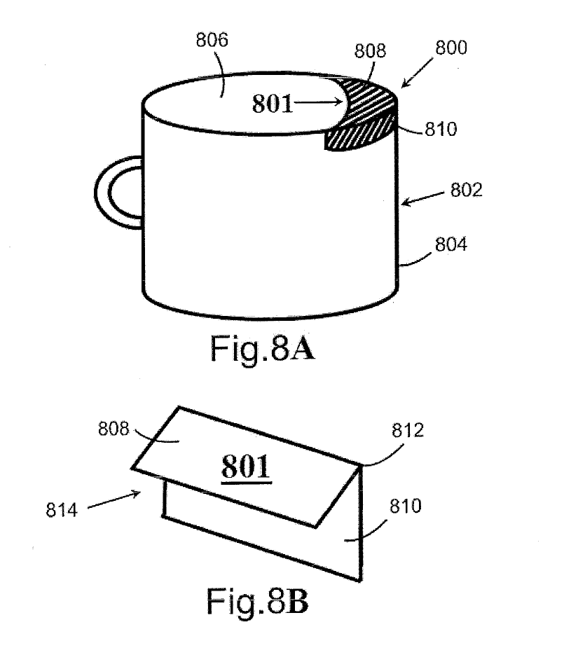

FIGS. 8A and 8B illustrate perspective views of a drinking assistant 801 for being used with a cup with an open top according to some embodiments of the present invention. A cup 802 includes an open top 806 and a body 804. A drinking assistant 801 for cup 800 can include an inner portion 808 coupled to the inner surface of the body 804, an outer portion 810 coupled to the outer surface of the body 804 and configured with the inner portion 808 to form a coverage 814, and a slit 812 formed underneath the coverage 814 for enforcing the engagement between the coverage 814 and the cup 802. The drinking assistant 801 is able to be a complete circle capable of covering the entire edge of the cup 800. The drinking assistant 801 with a complete circle is able to be carried as a wrist band.

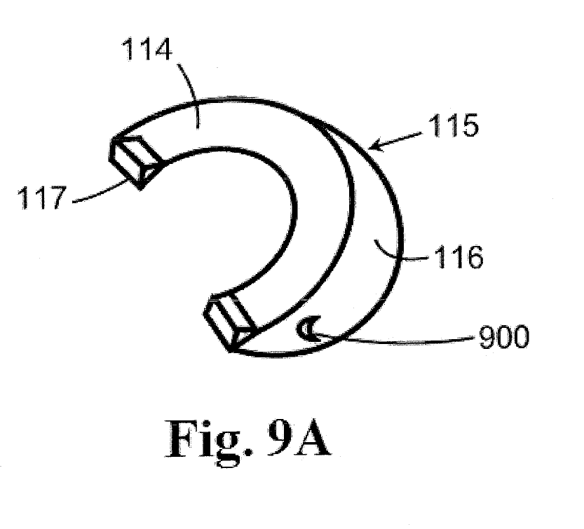

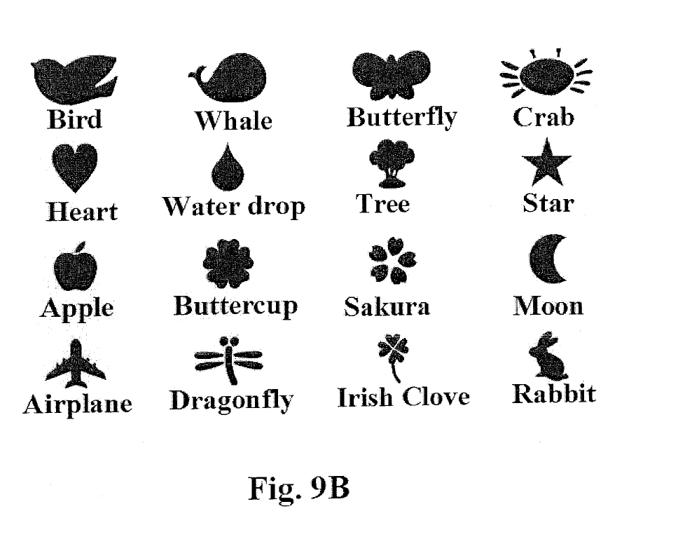

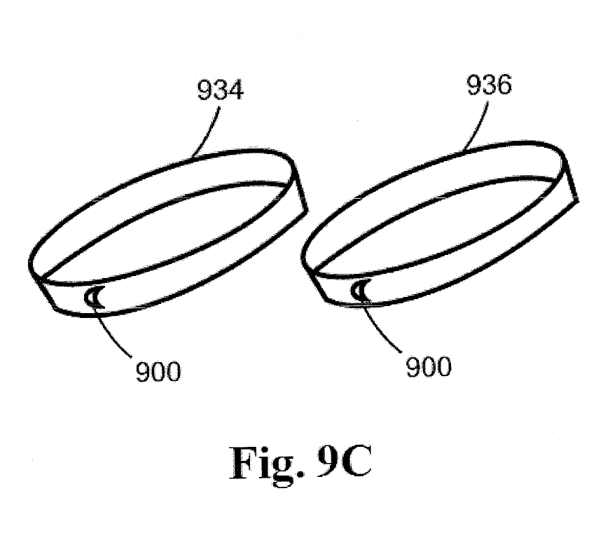

FIG. 9A illustrates a perspective view of a drinking assistant with an identification system. The drinking assistant 100 can include an identification system to help a user to identify his/her own can, cup, or any other drinking container. The identification system can be an identifier 900 embossed or carved on the lid structure 115.

FIG. 9B illustrates a list of various identifiers with different colors and image designs, including, but not limited to, a bird identifier 902, a heart identifier 904, an apple identifier 906, an airplane identifier 908, a whale identifier 910, a water drop identifier 912, a buttercup identifier 914, a dragonfly identifier 916, a butterfly identifier 918, a tree identifier 920, a sakura identifier 922, a Irish clover identifier 924, a crab identifier 926, a star identifier 928, a moon identifier 930, a rabbit identifier 932, etc.

FIG. 9C illustrates a perspective view of another identification system. The identification system can include a pair of bands 934 and 936 with the same or matched identifier 900 on it, one of which is coupled to a drinking container, and the other of which is wore by a user. By using the pair of bands, a user can identify his/her own drinking container. For example, a user is given two bands with same color and same identification, such that the user is able to know which can belongs to him/her by checking the color and identification band that is wore by him/her. The bands are able to be used in a match game. The band can be made of silicone, plastic, polymer, elastomer, and any other elastic materials.

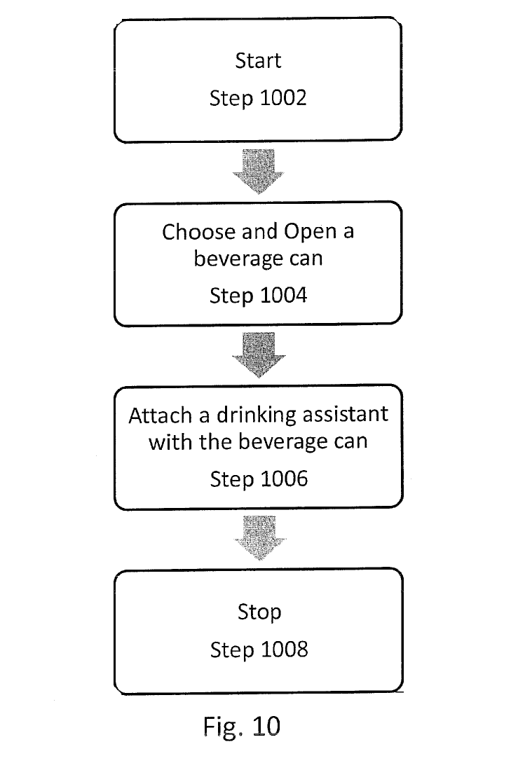

FIG. 10 is a flow chart illustrates a method of using a drinking assistance in accordance with the some embodiments of the present invention. The method is able to begin At Step 1002. At Step 1004, a beverage can is chosen and opened. At Step 1006, a drinking assistant is attached to the beverage can. The attachment is able to be achieved by pressing the drinking assistant to grip on the rim of the beverage can. At Step 1008, the method is able to stop.

In the following a drinking assistant with an identification system, in accordance with some embodiments, similar to the identification system in FIG. 9A is provided. In some embodiments, an elastic illuminating device is provided. The illuminating device is able to be an adjustable band. The device fulfills the need for both identification of a beverage container in dark conditions and ornamentation of the beverage container for personal expression.

In some embodiments, the illuminating device is able to be used for beverage container identification in dark and for personal expression. In some embodiments, the illuminating device comprises an elastic band, which is able to be applied on a beverage container. The illuminating device is able to contain chemicals for a spontaneous reaction, which emitting a light when one or more chemical reactions occur. For example, two chemicals contained in different zones in the elastic band is able to be mixed at use, such that a chemical luminescence reaction occurs at a trigger.

In some embodiments, the illuminating device is able to emit visible light, infrared light, fluoresce, phosphorescence, UV, or a combination thereof. In some embodiments, the illuminating device is able to contain a switch, a lighting part (e.g., LED), a power source (such as a battery), a elastic band housing hosting the elements disclosed thereof.

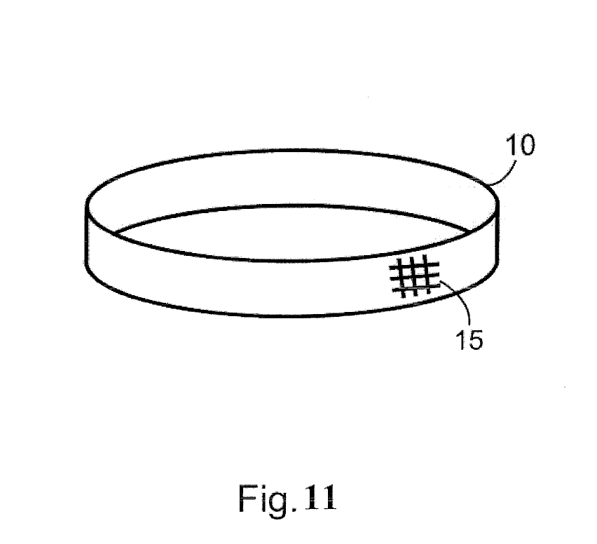

FIG. 11 is a right top perspective view of an elastic band 10 according to some embodiments of the present invention. The elastic band 10 is made of an elastomeric material with a woven or un-woven covering, which can change along its length according to the side of beverage bottle or container. The elastic band 10 is able to have curved edges, sharp edges or a combination thereof. In addition, the cross section of the elastic band 10 is able to be circular, rectangular, oval, heart-shaped, trapezoidal or any other shapes. The elastic band 10 is able to be used to personalize or identify the beverage container by stretching around and mounting lightly to the beverage container.

In some embodiments, the elastic band 10 includes a florescent material (chemical luminescence) 15 on the surface of the elastic band 10. The application of the florescent material 15 is able to increase the readability or identification ability of the elastic band 10 in the dark conditions. In some embodiments, the florescent material 15 is able to be other self-illumination materials, such as phosphorescence. Also, different colors can be implemented into the florescent material 15 to create the identification or personal preference.

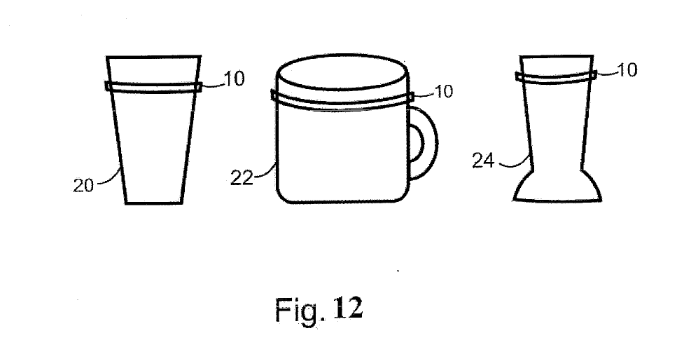

FIG. 12 illustrates the application of the elastic band in accordance with some embodiments. The elastic band 10 is able to be applied to different sizes of beverage glasses 20, pitcher 22 and cup 24 according to some embodiment of the present invention. The length or circumference of the elastic band 10 is able to be larger than the width of the band or alternatively, the band width is be greater than the circumference of the band and thereby extend over a larger portion of a bottle. As shown in FIG. 2, the circumference of the elastic band 10 is able to be adjusted to a point that the elastic band 10 does not slip from any size of the beverage cup with its elastic characteristic.

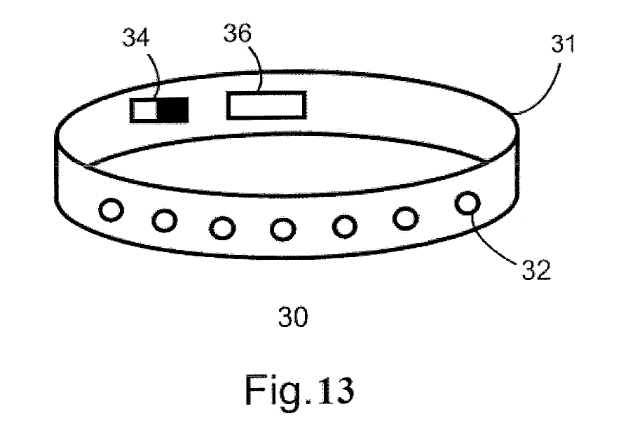

FIG. 13 is a right top perspective view of an elastic illuminating device 30 according to some embodiments of the present invention. The elastic illuminating device 30 comprises an elastic housing 31, a LED module 32, a switch module 34, and a power supply 36. The elastic housing 31 is able to be made of an elastomeric material covered with a photo luminescence florescent material. The elastic housing 31 is able to change its length according to the side of beverage bottle or container. In some embodiments, the switch module 34 is able to be a trigger mechanism. The trigger mechanism is able to trigger a chemical reaction (e.g., chemical luminescence) to occur, such that the elastic illuminating device 30 is able to emitting light.

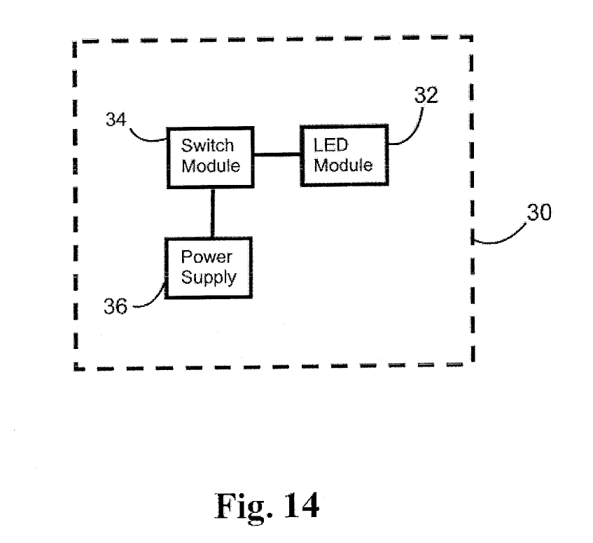

FIG. 14 is a block diagram of the elastic illuminating device 30 (FIG. 13) according to some embodiments of the present invention. The LED module 32, the switch module 34, and the power supply 36 are able to be wrapped under the elastic housing 31 for the protection from any impacts, such as physical impact. In some embodiments, the LED module 32 includes a plurality of light emitting diodes (LEDs) (as shown in FIG. 3), for emitting light with different color and brightness in constant light or blinking randomly or in a pre-determined manner. In some embodiments, the LEDs are arranged longitudinally upon the surface of the elastic housing 31. The user can select or program the desired color or pattern of LEDs for his identification or ornamentation of the beverage container for personal expression.

The power supply 36 is able to couple with the LED module 32 through the switch module 34, for providing the required power to the LED module 32. The power supply 36 can comprise Li-ion, Ni-MH, or solar battery. Next, the switch module 34 is coupled to the LED module 32 and the power supply, for turning on or off the LED module 32. The switch module 34 can be implemented by a physical switch, by a motion detector, by a timer, or automatically with a pre-determined condition. For example, the switch module 34 is able to comprise a motion detector for detecting the user's gesture (e.g., waving the elastic illuminating device 30 twice) to activate the LED module 32 accordingly. Similar principle applies to user's other gesture for turning off the LED module 32. Thus, by implemented the proposed elastic illuminating device 30, the user can easily identify his or her beverage container by the unique color and brightness of the LED module 32, even in the dark environment.

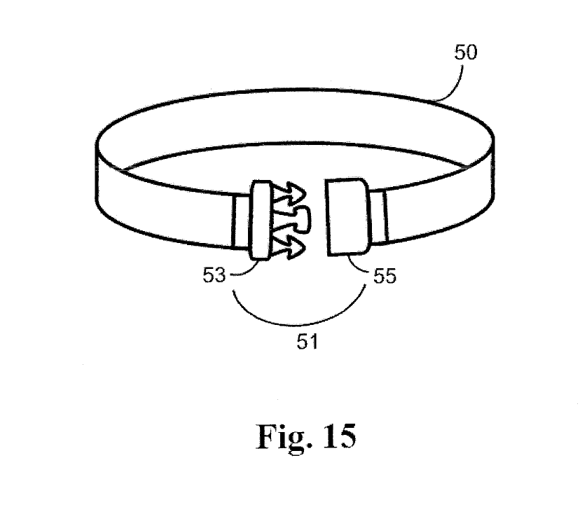

The elastic illuminating device in accordance with some embodiment is able to be a continuous loop or a connectable loop. In some embodiments, connectable loop of the elastic illuminating device has two terminating ends with a fastener applied. FIG. 15 is an elastic illuminating device 50 according to some embodiments of the present invention. The elastic illuminating device 50 has two terminating ends with a fastening device 51. The fasten device 51 comprises a male end 53 and a female receiving end 55. In some embodiments, one terminating end is able to be a hook portion, while the other terminating end contains a small circle for insertion of the hook. The fasten device 51 can fasten both ends of the elastic illuminating device 50 by inserting the male end 53 into the female receiving end 55, and detach the elastic illuminating device 50 by simultaneously pinching both sides of the male end 53 and female receiving end 55. The mechanism of the fasten device 51 allows for the ends to be securely fastened while still allowing for adjustable size capability depending on the size of the beverage container.

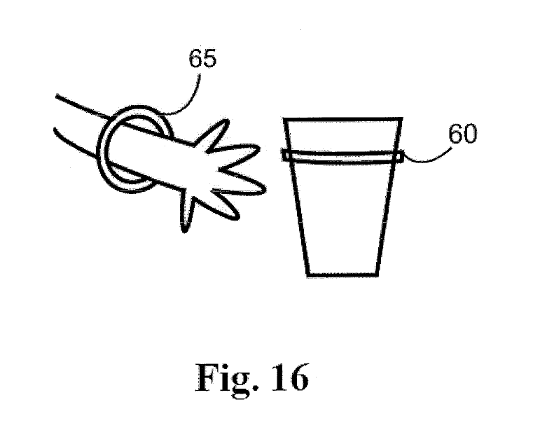

FIG. 16 is a schematic diagram illustrating an identification match system on the elastic illuminating device 60 in accordance with some embodiments of the present invention. The identification match system further includes another elastic band 65 applied to the user's hand for identification purpose. Here, the elastic band 65 is able to have the same color or characteristic with the elastic illuminating device 60. By wearing the elastic band 65 on the hand, the user can match the color of the elastic band 65 with the elastic band 65, and immediately find his/her beverage accordingly.

The drinking assistance is able to be utilized on drinking devices, such as standard 12 oz. soda can. In operation, a beverage can is opened and an drinking assistance is applied, such that a user is able to use the beverage with the help of the drinking assistance. The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A drinking assistant comprising:
a) a cover portion configured to cover at least a portion of a top of a drinking can; and
b) a skirt portion extending from the cover portion along a contour of an edge of the drinking can, wherein the cover portion contains a recess opposite to the side of the skirt portion.

2. The drinking assistant of claim 1, wherein the cover portion and the skirt portion forms a lid structure to be instantly attached to and removed from the drinking can.

3. The drinking assistant of claim 1, wherein the cover portion and the skirt portion forms a groove structure capable of engaging a rim of the drinking can.

4. The drinking assistant of claim 1, wherein the recess forms an incomplete circle on the cover portion.

5. The drinking assistant of claim 1, wherein the recess is opposite to an opening ring of the drinking can.

6. The drinking assistant of claim 1, wherein the recess is substantially aligned with a contour of an opening of the drinking can.

7. The drinking assistant of claim 1, wherein the cover portion contains an edge perpendicular to the cover portion extending toward an opening of the drinking can.

8. The drinking assistant of claim 7, wherein the edge elastically fits with a ridge of the opening.

9. The drinking assistant of claim 1, further comprising a flow stopper on the cover portion capable of preventing fluid from flowing on the top of the drinking can.

10. The drinking assistant of claim 9, wherein the flow stopper joining with the recess forms an end of the cover portion.

11. The drinking assistant of claim 1, wherein the drinking assistant comprises a material of a silicone, a plastic, a polymer, an elastomer, a metal, or a combination thereof.

12. The drinking assistant of claim 1, wherein the skirt portion contains a surface having an area sufficient for resting a human lip.

13. The drinking assistant of claim 1, further comprising an identification system.

14. The drinking assistant of claim 13, wherein the identification system comprises a symbol, text, or a combination thereof.

15. The drinking assistant of claim 14, wherein the identification system is embossed or carved on the drinking assistant.

16. The drinking assistant of claim 1, wherein the cover portion surrounds less than whole of a rim of the drinking can.

17. A method of using a drink assistant comprising:
a) attaching a cover with a can covering at least a portion of a top of the can; and
b) aligning a recess of the cover with an opening of the can.

18. The method of claim 17, wherein the recess forms an opening facing an opening-ring of the can.

19. The method of claim 17, wherein the cover forms an insulation layer, such that a user is able to drink the beverage without having a lip of the user to touch the can.

20. A drinking assistant comprising:
a) a cover member comprising a recess, wherein the recess has an area substantially similar in size of an opening area of a beverage can;
b) a skirt member having a contour substantially parallel to an area of the beverage can between a cylindrical body and a rim of the beverage can;
c) a rim member connecting the cover member and a skirt member forming a groove capable of engaging the rim of the beverage can;
d) a flow barrier connecting with the rim member such that beverage is confined on the cover member; and
e) an identification symbol identifying the beverage can.
